(19) United States
(12) Patent Application Publication
(10) Pub. No.: US 2015/0030808 A1
(43) Pub. Date: Jan. 29, 2015

(54) Reinforced Foam Laminates and Methods of Reinforcing Foam Laminates

(71) Applicant: Craig Cushman, Tempe, AZ (US)

(72) Inventor: Craig Cushman, Tempe, AZ (US)

(21) Appl. No.: 14/376,609

(22) PCT Filed: Nov. 13, 2012
(86) PCT No.: PCT/US12/64849

§ 371 Date: Aug. 4, 2014

Related U.S. Application Data
(60) Provisional application No. 61/643,292, filed on May 6, 2012.

(51) Int. Cl. B32B 7/04; B32B 37/14; B32B 27/06; B32B 3/26; B32B 5/02; B32B 5/24

(52) U.S. Cl. CPC B32B 7/045; B32B 5/028; B32B 5/245; B32B 27/06; B32B 3/266; B32B 37/142; B32B 2250/03; B32B 2305/022; B32B 2305/38; B32B 2305/08
USPC 428/139; 428/523; 428/304.4; 428/138; 442/1; 428/189; 156/60; 156/309.9

(57) ABSTRACT

Foam laminates reinforced by securing a reinforcement member between the layers of the laminate. The reinforcement member is secured between the sheets of foam that comprise the laminate during the lamination process. Spaces in the surface of the reinforcement member allow the foam sheets to bond to one another during lamination, securing the reinforcement member without additional steps or material.

### TECHNICAL FIELD

The field of the invention is laminates, more particularly foam laminates.

### BACKGROUND ART

There are many laminates and methods of creating laminates known in the art. Laminates are made by bonding multiple layers of material together. Many materials are used as layers in laminates, including foam, and those layers typically give a laminate its characteristics. At times, a laminate will have desired characteristics, but will lack strength needed for the final product.

One way laminates are strengthened is by using thicker layers of the same types of material. Thicker layers of foam require more material, which increases costs. Thicker layers also result in a bigger, heavier, less flexible final product. Alternatively, laminates can be strengthened by using different, stronger materials. Suitable materials do not always exist, and even when they do they will usually have less desirable characteristics (these can be physical characteristics or intangibles such as cost and availability). These less desirable characteristics impact the characteristics of the final laminate product.

Laminates have also been strengthened by laminating in an additional reinforcement layer. The additional layer adds the strength needed without changing the materials used in the rest of the laminate, but these layers typically add weight, size, and cost to the final product and decrease flexibility. Further, the additional lamination needed to add the additional layer increases costs and time required to create the laminate. For continuous, in-line production, an additional laminating apparatus is required. Using the same laminating apparatus for the second lamination requires the time, effort, and space needed to relocate and re-prepare the product of the first lamination.

While each of these solutions can result in a stronger laminate, each negatively impacts the laminate and/or increases the cost and difficulty of producing the laminate. Thus, there remains a considerable need for stronger laminates and methods of strengthening laminates.

### DISCLOSURE OF THE INVENTION

The present invention is directed to reinforced foam laminates and methods of reinforcing foam laminates. In particular, the invention contemplates reinforcing foam laminates by securing a reinforcement member between the materials being laminated together during the lamination process.

Securing a reinforcing member between foam layers being laminated together at the time of lamination is desirable. Previously, when a foam laminate needed to be reinforced, a separate reinforcing layer was added to the laminate. Adding another layer to a laminate requires an additional lamination. For continuous in-line production, that additional lamination would require an additional laminating apparatus. To use the same apparatus for both laminations would require the time, effort, and space needed to relocate and re-prepare the product of the first lamination. By securing the needed reinforcement during the lamination process, these additional costs and inconveniences can be avoided.

The reinforced laminates created by this process can have desirable characteristics not found in foam laminates reinforced by other methods. When reinforcing a laminate by laminating in a separate reinforcement layer, the reinforcement layer can have attributes (including cost and availability) detrimental to the product as a whole—after all, if the reinforcement layer had all the desired characteristics in addition to needed strength, the entire laminate would be created with this material. These detriments are simply accepted for the benefit of strengthening the final product. Securing a reinforcing member between layers of a laminate, rather than laminating in an entire new layer, opens the door for the possibility of adding the desired strength to the finished product while avoiding the corresponding detriments.

For example, in a preferred embodiment of the invention, two sheets of polyethylene foam are laminated together, and netting is secured between the two sheets during lamination. The laminate is used as a large floatation device, so buoyancy and durability are desirable. The floatation device is rolled up for storage when not in use, so flexibility is also desirable to make rolling the device easier and reduce the size of the device when rolled. While the two sheets of foam alone maximize flexibility and buoyancy, they lack the necessary durability. Previously, durability was increased by laminating an additional layer of much denser foam between the two foam sheets. This layer increased durability, but decreased flexibility and buoyancy. The contemplated embodiment was able to deliver the needed durability without reducing buoyancy or flexibility, and the netting was less expensive than the dense foam layer.

To practice the invention, an appropriate reinforcement member must be used. In order to be able to secure the reinforcement member during the lamination process, the reinforcement member must be thin enough and leave enough space that the other layers are able to bond as they normally would. Once an appropriate reinforcement member is selected, lamination is performed, with the reinforcement member placed between the two materials being laminated. Some tweaks may be necessary, but the lamination process should remain largely the same and the tweaks needed would require minimal experimentation and would be obvious to one skilled in the art.

Various objects, features, aspects, and advantages of the present invention will become more apparent from the following detailed description of a preferred embodiment of the invention, along with the accompanying drawings.

### BRIEF DESCRIPTION OF THE DRAWINGS

FIG. 1 is a side view of an exemplary embodiment.

FIG. 2 is a cross-sectional perspective view of an exemplary embodiment.

FIG. 3 is a top view of an exemplary reinforcement member.

FIG. 4 is a top view of an exemplary reinforcement member.

FIG. 5 is a top view of an exemplary reinforcement member.

### BEST MODES

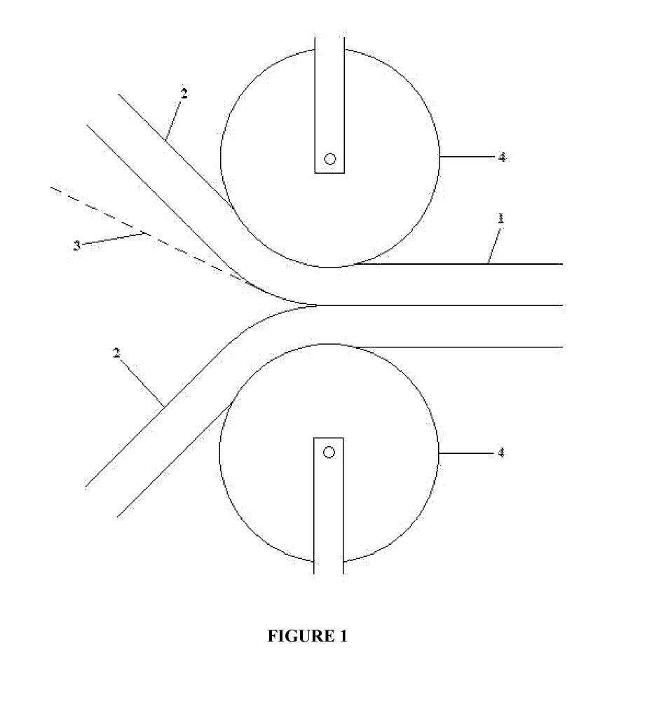

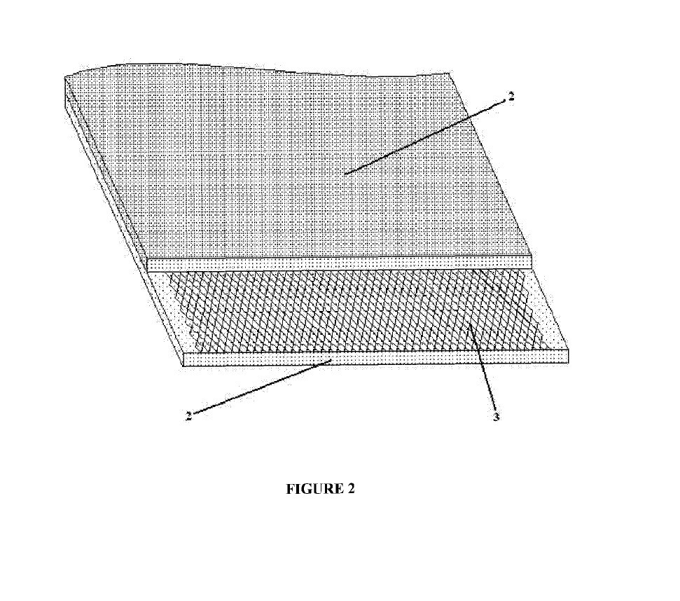

A preferred embodiment of the invention involves laminating netting between two sheets of two-pound-per-cubic-foot density polyethylene foam. The netting is 420 denier woven, untreated polyester netting with two-inch square holes. The lamination is depicted in FIG. 1. The foam sheets 2 are bonded together using flame lamination, a process known in the art, where the surfaces of the foam sheets 2 are heated then immediately brought together and pressed by rollers 4, causing the sheets to bond. The spaces in the netting 3 allow the netting to be fed between the two foam sheets 2 during the flame lamination process without preventing the two foam sheets 2 from bonding with one another. The resulting laminate 1 is depicted in FIG. 2. There, the top foam sheet 2 is cut away to show the netting 3 secured between the two foam sheets 2. The edges of the foam sheets 2 extend further than the edges of the netting 3. As a result, the netting 3 is not exposed on the side of the laminate, resulting in a more finished looking product and preventing sharp points that can result from cutting netting made of certain materials.

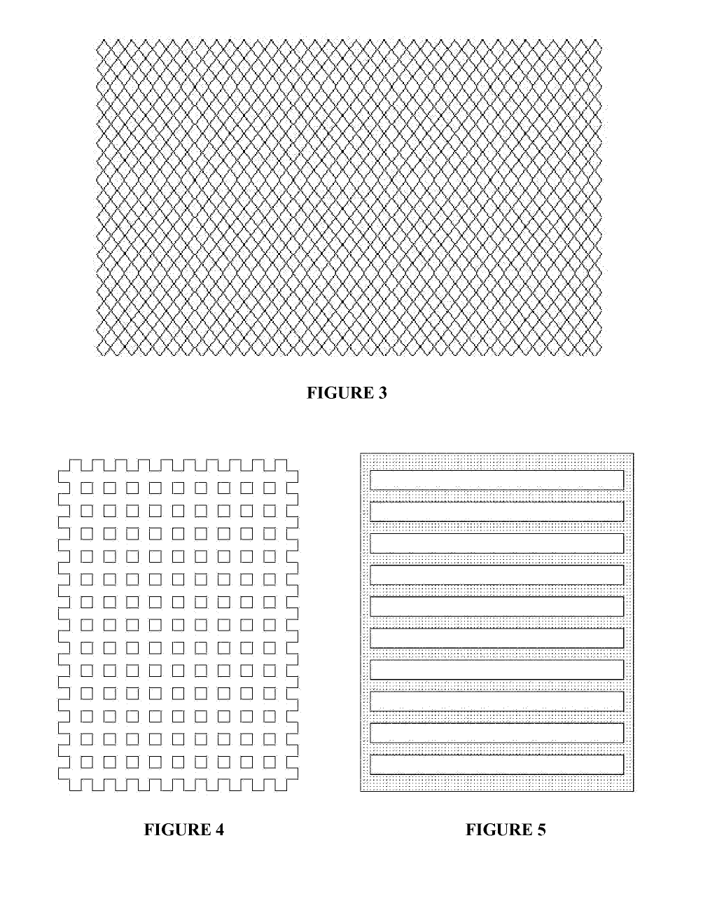

While netting is used as a reinforcement member in the preferred embodiment, other embodiments are contemplated. FIG. 3, FIG. 4, and FIG. 5 show different examples of possible reinforcement member shapes. FIG. 3 is netting, like that used in the preferred embodiment. FIG. 4 and FIG. 5 are sheets of a material with spaces in their surface. The layers of the laminate would bond together through the spaces in these reinforcement members, securing the reinforcement member between the two.

What is claimed is:

1. A laminate comprising:
A first planar member;
A second planar member attached to the first planar member; and
A reinforcement member interposed between the first and the second planar member.

2. The laminate of claim 1 further comprising:
At least one of the planar members being a sheet of thermoplastic resin.

3. The laminate of claim 1 further comprising:
At least one of the planar members being foam.

4. The laminate of claim 2 further comprising:
The foam is polyethylene foam.

5. The laminate of claim 1 further comprising:
The reinforcement member does not prevent the first planar member and the second planar member from bonding with one-another.

6. The laminate of claim 1 further comprising:
The reinforcement member is planar/sheet-like with spaces in its surface.

7. The laminate of claim 1 further comprising:
The reinforcement member is netting.

8. The laminate of claim 1 further comprising:
The edges of the first planar member and the second planar member extend further than the edges of the reinforcement member.

9. The laminate of claim 1 further comprising:
The first planar member and the second planar member are bonded together by heating the surfaces and applying pressure.

10. The laminate of claim 1 further comprising:
The first planar member and the second planar member are bonded together through gaps in the surface of the reinforcement member.

11. A method of creating a laminate comprising:
Bonding at least two sheets of material together; and
securing a reinforcement member between the sheets of material simultaneous with the bonding.

12. The method of claim 11 further comprising:
At least one of the sheets of material is a thermoplastic resin.

13. The method of claim 12 further comprising:
The thermoplastic resin is polyethylene foam.

14. The method of claim 11 further comprising:
The sheets of material are bonded together by heating the two surfaces to be bonded, placing the two surfaces together, and applying pressure to the opposite sides of the sheets.

15. The method of claim 11 further comprising:
The reinforcement member has a non-continuous surface which allows the sheets of material to bond with one-another while the reinforcement member is in between.

16. The method of claim 11 further comprising:
The reinforcement member is netting.

17. A method of creating a laminate comprising:
Placing a planar reinforcement member with spaces in its surface between two sheets of material; and
Bonding the two sheets of material together through the spaces in the reinforcement member.
